(19) United States
(12) Patent Application Publication
(10) Pub. No.: US 2006/0096434 A1
(43) Pub. Date: May 11, 2006

(54) Ultrasonic slitter

(75) Inventors: Krzysztof Mosiewicz, Chicago, IL (US); Vijay K. Arora, Lake Forest, IL (US)

Correspondence Address: KRAFT FOODS INC, THREE LAKES DRIVE, NORTHFIELD, IL, 60093-2753, US

(73) Assignee: Kraft Foods Holdings, Inc.

(21) Appl. No.: 11/314,660

(22) Filed: Dec. 20, 2005

Related U.S. Application Data
(62) Division of application No. 10/689,161, filed on Oct. 20, 2003.

(51) Int. Cl. B26D 1/06

(52) U.S. Cl. 83/614; 83/956

(57) ABSTRACT

Apparatus for high-volume, high speed ultrasonic cutting or slitting comprising a blade having first and second cutting edges suspended from a reciprocating head, cantilevered over a conveyor supporting and advancing the food product, with the blade including first and second cutting edges on respective opposite sides thereof to cut the food product transversely. The head is preferably controlled for automated operation by an electronic controller to reciprocate transversely at a selected speed and a selected frequency within predetermined ranges over food product advancing on the conveyor. The blade preferably oscillates ultrasonically, and preferably at a frequency of approximately 20,000 Hz. The first and second cutting edges are preferably downwardly convergent, defining an included angle greater than 60 degrees and less than 90 degrees. In one particular embodiment, the internal angle is 70 degrees. In another embodiment, the angle is about 60 degrees. The blade may have a linear translating velocity of 25 to 35 inches per second, and more specifically may have a transverse velocity of approximately thirty inches per second. The apparatus may be used in high-speed, high-volume commercial food production operations for automated cutting of cheese products and other food products from large chunks, slabs and the like into smaller portions, and may also be used in other applications.

This is a division of prior application Ser. No. 10/689161, filed Oct. 20, 2003.

### FIELD OF THE INVENTION

The invention relates to apparatus for cutting food products such as cheese products, and specifically to an ultrasonic slitter.

### BACKGROUND OF THE INVENTION

U.S. Pat. No. 6,403,138, incorporated by reference herein, describes use of a particular type of ultrasonic cutting apparatus in connection with making retail-sized cheese chunks in a continuous process. Various other types of cutting apparatus are used in other high-speed, high-volume commercial food production operations for automated cutting of cheese products and other food products from large chunks, slabs and the like into smaller portions.

In certain high speed commercial operations for manufacturing, packaging, and otherwise processing food products, ultrasonic cutting apparatus may be preferable to conventional blades for a number of reasons. Ultrasonic blades may provide a superior quality of cut by avoiding adherence of food products such as nougat or icing, and may also be capable of cutting at higher speeds through products such as cheese.

The prior art includes ultrasonic cutters known as a guillotines which are used to make transverse cuts in food products on conveyors. The guillotine blade is cantilevered over the conveyor and driven downward into a product supported on a conveyor, and is then raised to permit the product to advance past the blade and position the product for the next transverse cut. The prior art also includes stationary ultrasonic slitters used to make longitudinal cuts as the product is advanced on the conveyor. Combinations of vertically reciprocating guillotines and stationary slitters have been used in the past to divide large moving sheets of food product into smaller rectangular portions.

The weight of the guillotine and associated transducer and amplifier results in practical limitations on the length of the guillotine blade and the speed at which the blade can be reciprocated. In one particular application, the maximum blade length is less than 14 inches, with the optimal length being 7 inches or less, and the linear velocity of the guillotine's reciprocation is limited to approximately 18 inches per second. Increasing the linear velocity beyond 18 in. per second results in excessive mechanical vibration. This produces poor cutting results, and creates stress which may damage system components. In this particular application, it has been found that the guillotine is able to provide at most approximately 75-85 cuts per minute, and only 65 quality cuts per minute.

### SUMMARY

The invention provides an improved ultrasonic cutting device for high speed cutting of food products. The apparatus preferably includes a double acting blade suspended from a reciprocating head, cantilevered over a conveyor supporting and advancing the food product, with the blade including first and second cutting edges on respective opposite sides thereof to cut the food product transversely. The head is preferably controlled for automated operation by an electronic controller to reciprocate transversely at a selected speed and a selected frequency within predetermined ranges over food product advancing on the conveyor. The first cutting edge cuts the food product when the head translates in a first direction, and the second cutting edge cuts food product during the return stroke. The blade preferably oscillates ultrasonically, and preferably at a frequency of approximately 20,000 Hz.

The first and second cutting edges are preferably downwardly convergent, defining an included angle greater than 60 degrees and less than 90 degrees. In one particular embodiment, the internal angle is 70 degrees. In another embodiment, the angle is about 60 degrees.

The cutting edges preferably are inclined at identical angles, and preferably intersect a horizontal bottom edge of the blade at identical obtuse angles. The food product preferably has generally vertical sides so that the transverse engagement of the food product by the blade results in initial engagement of an upper corner portion of the food product by the blade, followed by continuously increasing engagement of the food product by the blade as the depth of penetration increases, with the blade moving horizontally and the resultant force on the food product being a vector having a downward component as well as a transverse horizontal component. The blade may have a linear translating velocity of 25 to 35 inches per second, and more specifically may have a transverse velocity of approximately thirty inches per second.

The apparatus may further include a stationary frame and a carriage translatably secured to the frame so as to be movable transversely relative to the direction of movement of the food product, where the carriage includes the blade and a head supporting the blade and providing ultrasonic mechanical vibration to the blade.

In one form, the conveyor may include conveyor sections separated by a gap, and an anvil positioned between the conveyor sections. The food product may pass over a bottom portion of the anvil and between side portions of the anvil as the food product is advanced by the conveyor, and the anvil preferably is capable of supporting and constraining the food product against downward displacement and against transverse displacement in either horizontal transverse direction. The anvil may include various elements for engaging the food product such as rotating elements, moving belts or O-rings, or stationary elements. The anvil preferably has a groove or channel in its lower portion having a width slightly greater than that of the blade to permit a lower portion of the blade to pass below a bottom surface of the food product as the food product is being cut. The anvil also preferably has side gaps which have a width greater than the thickness of the blade to permit the blade or portions thereof to pass through laterally beyond the sides of the anvil.

The frame may be secured to a base, and may include one or more rails for guiding lateral translation of the carriage. The carriage may include a slide translatably secured on each rail. The device may include a drive slide to which translating force is provided, and a drive rail to which the drive slide is translatably secured. The head may include a signal generator and an amplifier to provide mechanical oscillation to the blade.

The invention may be used in high-speed, high-volume commercial food production operations for automated cutting of cheese products and other food products from large chunks, slabs and the like into smaller portions, and may also be used in other applications.

### BRIEF DESCRIPTION OF THE DRAWINGS

FIG. 1 is a front elevational view of a bi-directional ultrasonic slitter and a conveyor;

FIG. 2 is a partial side elevational view of the apparatus of FIG. 1;

FIG. 3 is another partial side elevational view thereof;

FIG. 4 is a partial plan view thereof;

FIG. 5 is a front elevational view of the blade of the apparatus; and

FIG. 6 is a side elevational view thereof.

### DETAILED DESCRIPTION OF PREFERRED EMBODIMENTS

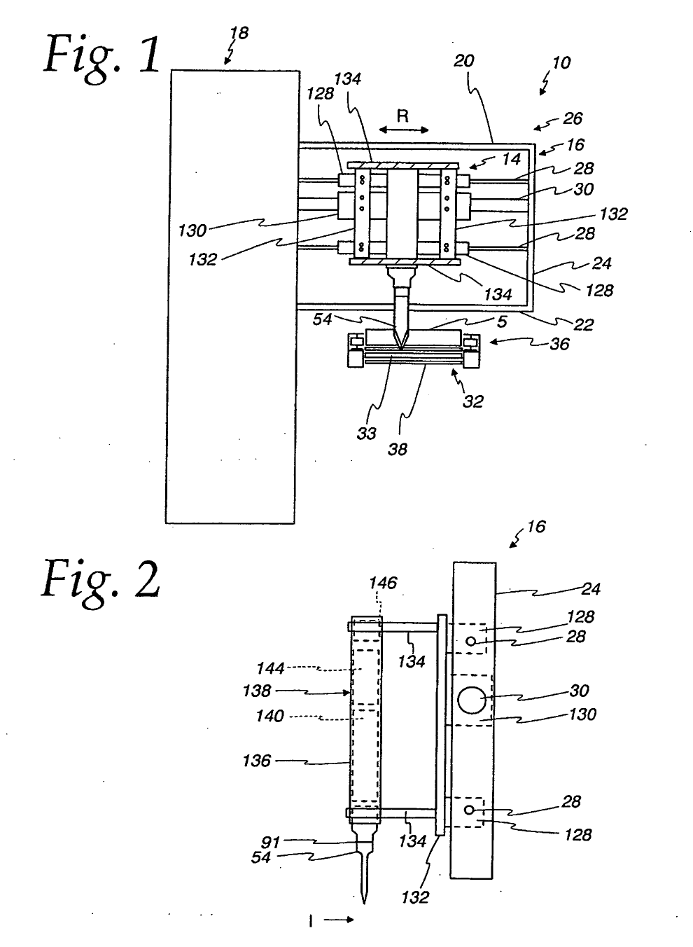

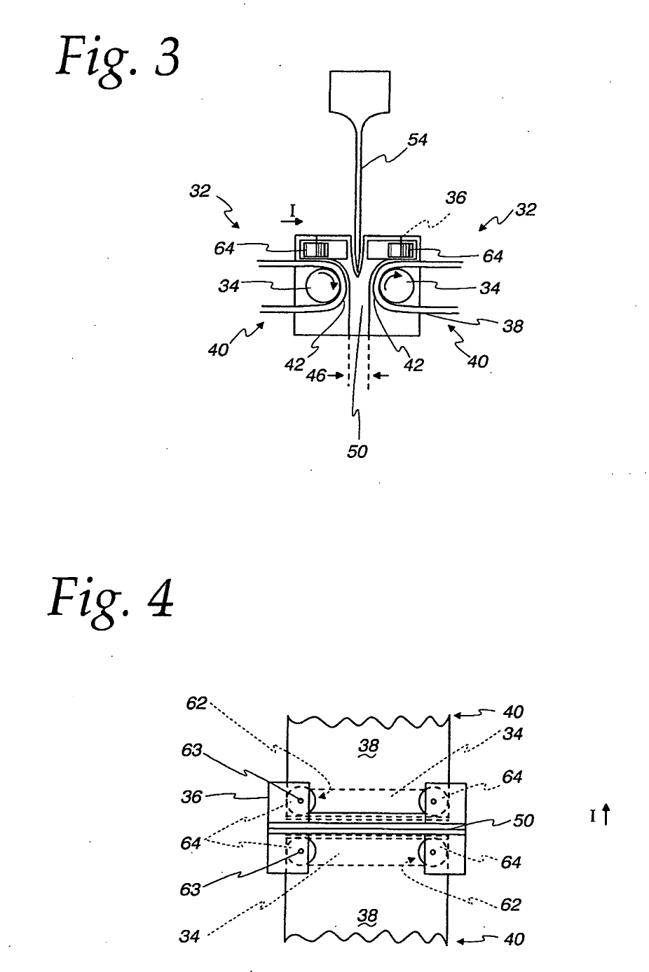

Referring initially to FIG. 1, the invention is preferably embodied in a bidirectional ultrasonic slitter 10 including a translatable carriage 14 supported on a frame 16 on a base 18. As described below, the slitter 10 forms transverse cuts in a food product slab 5 supported on a conveyor assembly 32 that includes an anvil 36 disposed between a pair of conveyors.

The structure of the apparatus may take various different forms. One particular structure is described below and shown in the drawings for purposes of example.

The illustrated base 18 includes operator controls and provides power for translation to the carriage 14. The illustrated frame 16 includes horizontal transverse top and bottom members 20 and 22 supporting a vertical side member 24. Guide rails 28 and drive rail 30 extend horizontally and parallel to one another transversely over the conveyor, supported at opposite ends by the base 18 and side member 24 respectively. The carriage 14 is slidably supported on the frame rails 28 and 30. The carriage 14 may reciprocate in a bi-directional manner as depicted by the arrow R along a path defined by the rails 28 and 30.

The illustrated carriage 14 includes guides 128 slidably mounted on guide rails 28 and a drive slide 130 supported on the drive rail 30. The guides 128 and drive slide 130 are mounted to vertical members 132 which are in turn mounted to horizontal, longitudinally extending upper and lower brackets 134. The brackets 134 support a head 136 including a blade 54 suspended from an oscillator 138 that includes a signal generator 144 and an amplifier 140. The oscillator 138 converts electrical energy supplied through a power coupling 146 into mechanical oscillation of the blade 54 at an ultrasonic frequency of about 20,000 Hz.

The electrical signal generator 144, amplifier 140, and power coupling 146 may be of a type available from Dukane Corporation of St. Charles, Ill., U.S.A., and RHM Technology, United Kingdom. The power coupling 146 may comprise a power cord and/or one or more connectors.

The illustrated conveyor assembly 32 comprises two or more conveyor sections 40 arranged in series. Each conveyor section may comprise a belt conveyor, O-ring conveyor, or other conveyor. Each of the illustrated conveyor sections includes end rollers 34 and one or more movable members 38 such as belts, bands, O-rings or the like. The food product is carried by the conveyor sections 32 in the direction of arrow I, with end rollers 34 of adjacent conveyor sections rotating in the direction of the arrows depicted thereon. In the illustrated embodiment, a stationary anvil 36 is disposed between the ends 42 of the conveyor sections 40 in a gap 46 supporting and constraining the food product against downward displacement and against transverse displacement in either horizontal transverse direction. The anvil 36 includes a transverse groove or channel 50 through which the blade 54 may pass such that the bottom of the blade 54 extends below the bottom side of a food product being cut.

The illustrated anvil 36 includes side members 62 that constrain the food product against lateral movement as the blade 54 engages the food product 58. The illustrated side members 64 are cylindrical elements freely rotatable about vertical axes 63, providing line contact between the rotating elements 64 and the food product. In other embodiments, the side members may comprise low friction stationary blocks or moving belts with flat surfaces for low pressure sliding engagement with the food product, or other elements.

As, the food product is moved continuously or intermittently past the anvil 36 by the conveyor 32, the carriage 14 translates in a first direction as shown by arrow R transverse to the direction of motion of the food product on the conveyor 32. The blade 54 translates from one side of the conveyor 32, through the channel 50 of the anvil 36 and through the food product, to the other side of the conveyor 32, thereby dividing the food product. The conveyor 32 continues to move the food product in the direction of arrow I, and the blade 54 translates across the conveyor in a second direction opposite the first direction, again passing through the channel 50 and dividing the food product.

The conveyor 32 may be a step conveyor which advances the food product stepwise past the blade in a series of intermittent movements, each having a longitudinal dimension corresponding to that desired for the portions into which the food product is being divided, with the conveyor pausing as each cut is made by the blade 54.

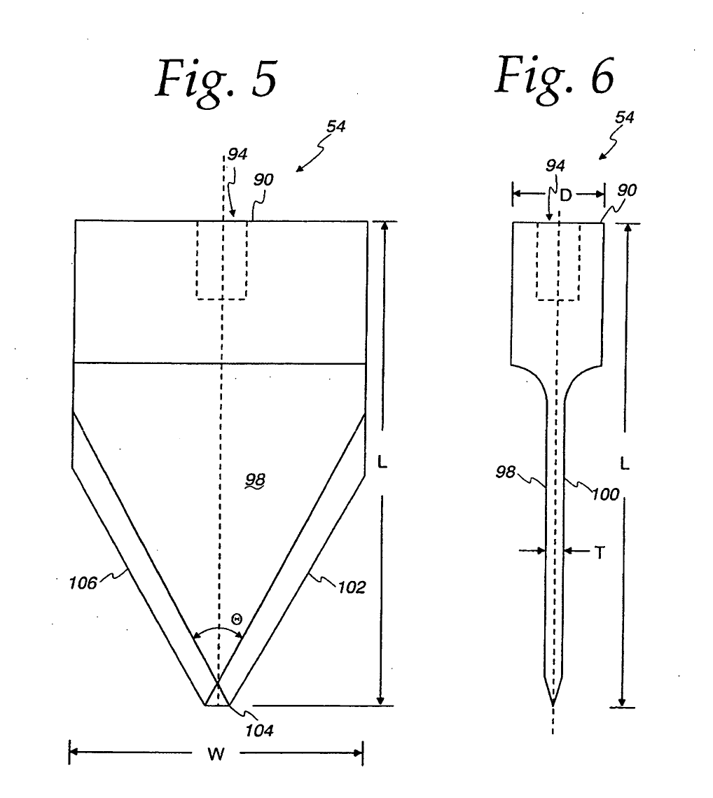

FIGS. 5-6 show a blade 54 in accordance with an embodiment of the invention. The blade 54 is preferably made of aluminum, stainless steel, titanium and/or other metal alloys, and is preferably manufactured to precise tolerances and tuned for ultrasonic oscillation at about 20,000 Hz.

The blade has an upper shank 90 having a thickness or depth D, and a lower cutting portion having reduced thickness or depth relative to the shank. The shank is supported and engaged by the head to permit ultrasonic oscillation across an interface 91 (FIG. 2) and has a socket 94 to receive a mounting screw, stud or other projection extending downward from the head 136. The depth D of the top face 90 is approximately 1 inch.

The blade 54 includes a front surface 98 and a back surface 100. As the blade 54 passes through food product, the front surface 98 and back surface 100 contact the food product. The amount of friction between the blade 54 and food product correlates to the surface area of the blade 54 that contacts the food product, and accordingly it is generally desirable to reduce the blade surface area contacting the food product. However, decreasing the size of the blade, i.e., decreasing the width W and angle θ defined by the cutting edges, decreases the strength and rigidity of the blade 54, which reduces the precision of the blade's cuts. In the illustrated embodiment, these factors are balanced by orienting the cutting edges 102, 106 at identical inclinations and with an internal angle θ of between 60 and 90 degrees. In one embodiment, the angle θ is between 65 and 75 degrees, or about 70 degrees. The thickness T of the cutting portion of the blade 54 is about one-eighth of an inch. The width W of the blade 54 is about 3 inches, and the overall length L is approximately 5 3/16 inches. With this configuration, in one example, the blade 54 may be operated at over 18 in. per second, and more specifically at over 30 in. per second, to make over 100 cuts per minute, and more specifically over 150 cuts per minute, through a slab of natural cheddar cheese having a height of about 2.5 in. and a width of about 10 in., with the blade clearing the cut at each end of each pass, providing cut surfaces that are smooth, shiny and free of burrs, separating a portion of said slab from the remainder thereof, leaving the knife clean and smear-free, without fines or dust.

While there have been illustrated and described particular embodiments of the present invention, it will be appreciated that the invention is not limited to the embodiments described above.

1-25. (canceled)

26. A method of bidirectional slitting of a food product using an ultrasonically oscillating blade without adhesion of said food product to said blade comprising:
supporting said blade from above;
oscillating said blade at a frequency of about 20,000 Hz.;
driving the blade transversely through said food product in a first transverse direction in a first stroke to displace said blade from a first side of said food product to a second side of said food product, thereby forming a first cut through the food product to sever a portion of the food product from the remainder of the food product, said driving being accomplished by applying lateral force to said blade with a movable support disposed above the food product; advancing the food product in a forward direction; and
driving the blade transversely through said food product in a second transverse direction in a second stroke to displace said blade from said second side of said food product to said first side of said food product, thereby forming a second cut through the food product at a location spaced from said first cut to sever a second portion of the food product.

27. The method of claim 24 wherein said blade has inclined downwardly convergent cutting edges on opposite ends thereof and said slab has substantially vertical sides, so that an upper portion of each of said cutting edges engages said slab before a lower portion thereof engages said slab in each of said strokes.

28. The method of claim 25 wherein said blade cuts entirely through a slab of natural cheddar cheese having a height of 2.5 in. and a width of 10 in. at a linear velocity of over 18 in. per second across the width of said slab, leaving a cut surface that is smooth, shiny and free of burrs, and separating a portion of said slab from the remainder thereof, leaving the knife clean and smear-free, without fines or dust, with said blade being supported from above.

29. The method of claim 26 wherein said blade cuts said slab at a linear velocity of over 18 in. per second.

30. The method of claim 27 further comprising additional strokes alternating between said first and second directions wherein said blade makes over 100 cuts per minute through said slab.

31. The method of claim 28 wherein said blade makes at least 150 cuts per minute through said slab and achieves a linear velocity of at least 30 in. per second.
